(19) United States
(12) Patent Application Publication
(10) Pub. No.: US 2026/0268300 A1
(43) Pub. Date: Sep. 10, 2026

(54) METHODS AND SYSTEMS FOR MONITORING CHECKOUT PROCESSES

(71) Applicant: Mehdi AFRAITE-SEUGNET, Paris (FR)

(72) Inventor: Mehdi AFRAITE-SEUGNET, Paris (FR)

(21) Appl. No.: 19/558,842

(22) Filed: Mar. 6, 2026

(30) Foreign Application Priority Data
Mar. 6, 2025 (FR) FR2502283

(51) Int. Cl. G06Q 20/20; G06V 20/40; G06V 20/52

(52) U.S. Cl. CPC G06Q 20/208; G06V 20/44; G06V 20/52; G06V 2201/07

(57) ABSTRACT

The invention relates to a monitoring system (2) intended to be deployed on a checkout terminal (1) incorporating a display device (13) configured to display information relating to an item (3) to be processed at a checkout, this system (2) comprising an image sensor (21) configured to acquire an image of said item (3); a processing module (22) configured to determine, in said image, a candidate item corresponding to said item (3) to be processed at a checkout; a capture device (23) configured to retrieve, in real time, display signals intended for the display device (13) and convert these signals into content in the predefined format; the processing module being furthermore configured to verify the presence or absence of information relating to the candidate item in said content.

The present invention relates to checkout systems, and more particularly to automatic checkout terminals. The present invention relates more specifically to monitoring methods and systems intended to be deployed on an automatic checkout terminal incorporating a display device configured to display information relating to an item to be processed at a checkout.

### BACKGROUND OF THE INVENTION

Automatic checkout terminals are understood to mean devices or terminals, commonly referred to as self-service checkouts, automatic checkouts or even self-checkouts, generally arranged at an exit of a self-service point of sale, allowing the customer to register their purchases themselves (carry out the operations of the checkout procedure themselves).

These automatic checkout terminals, although they offer many benefits, such as reduced customer waiting time and lower labour costs for the point of sale, are often subject to fraudulent acts known as “inventory shrinkage”. The point of sale therefore suffers a loss of profit.

More generally, automatic checkout terminals pose new challenges in terms of controlling inventory shrinkage. These problems may occur
intentionally, through deliberate acts carried out by malicious customers, for example by intentionally changing or substituting the barcode or label of an item with a label indicating a lower price, not registering an item, or even by leaving the automatic checkout terminal without paying, or
unintentionally, for example due to human errors such as a registration error, such as presenting an incorrect barcode when the item has several thereof (for example, one barcode for the pack and another barcode for an element in the pack), or forgetting to register an item.

Human monitoring creates additional costs, which could offset some of the savings expected from automation. In addition, with the proliferation of automatic checkouts, it is often difficult to be able to simultaneously supervise multiple customers at different stages of the checkout procedure, increasing the risk of thefts going unnoticed. Inventory shrinkage is facilitated further when the customer is in collusion with the person supervising the automatic checkout terminals.

The increased use of the proliferation of surveillance cameras has several drawbacks. In addition to being expensive and technically complex to manage, an excessively large number of cameras may be negatively perceived by honest customers. This impression of excessive surveillance risks harming their shopping experience, generating a sense of discomfort or mistrust, which may ultimately affect their loyalty to the point of sale.

One aim of the present invention is to remedy the abovementioned drawbacks.

Another aim of the present invention is to effectively prevent inventory shrinkage and unintentional errors without impacting the customer's shopping experience or the pre-existing checkout software.

Another aim of the present invention is to ensure complete monitoring of the checkout procedure, ensuring that all items to be processed at a checkout are correctly registered and paid for, without any omissions or errors.

### SUMMARY OF THE INVENTION

To this end, what is proposed, firstly, is a monitoring system intended to be deployed on a checkout terminal incorporating a display device configured to display information relating to an item to be processed at a checkout, this system comprising
an image sensor configured to acquire an image of said item; a processing module configured to determine, in said image, a candidate item corresponding to said item to be processed at a checkout;
a capture device configured to retrieve, in real time, display signals intended for the display device and convert these signals into content in the predefined format; the processing module being furthermore configured to verify the presence or absence of information relating to the candidate item in said content.

Various additional features may be provided, on their own or in combination:
the capture device comprises a splitter for duplicating the display signals intended for the display device;
the processing module is configured to verify the presence or absence of information relating to the candidate item in a portion of said content;
the processing module is furthermore configured to extract a text from said content, the presence or absence of said information being verified in the extracted text;
the processing module, to determine the candidate item, uses one or more attributes of the item other than a barcode;
the monitoring system furthermore comprises a sound sensor configured to capture a predefined sound emitted by the checkout terminal;
the processing module is furthermore configured to determine, from said image and said content, a sequence of events occurring during a checkout procedure and to generate a message when said sequence of events deviates from a predefined sequence of events.

What is proposed, secondly, is a method for monitoring a checkout procedure on a checkout terminal incorporating a display device configured to display information relating to an item to be processed at a checkout, this method comprising the following steps
acquiring an image of said item by way of an image sensor;
determining, at least from the acquired image, a candidate item corresponding to said item to be processed at a checkout;
retrieving, in real time and by way of a capture device, display signals intended for the display device and converting these signals into content in the predefined format;
verifying the presence or absence of information relating to the candidate item in said content.

Various additional features may be provided, on their own or in combination:
the monitoring method furthermore comprises a step of extracting a text from the content of the display signals, the presence or absence of said information being verified in the extracted text;
the monitoring method furthermore comprises a step of determining, from said image and said content, a sequence of events occurring during a checkout procedure and a step of generating a message when the sequence of events deviates from a predefined sequence of events.

### BRIEF DESCRIPTION OF THE DRAWINGS

Other features and advantages of the invention will become more clearly and specifically apparent on reading the following description of embodiments, said description being given with reference to the appended drawings, in which

FIG. 1 schematically illustrates an automatic checkout terminal equipped with a monitoring system according to various embodiments;

FIG. 2 schematically illustrates steps of a method for monitoring a checkout procedure on an automatic checkout terminal according to various embodiments.

### DETAILED DESCRIPTION OF THE PREFERRED EMBODIMENTS

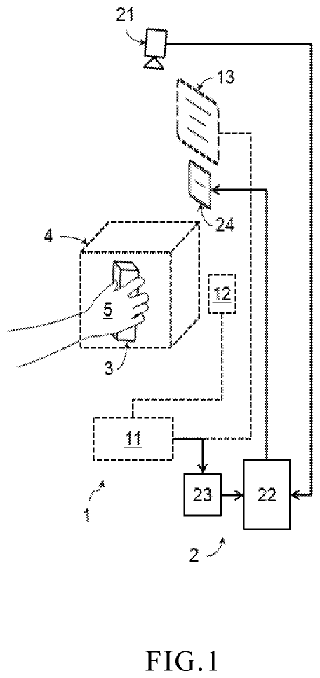

FIG. 1 shows elements of an automatic checkout terminal 1, in particular a central processing unit 11 capable of executing checkout software or, more generally, a computer program product dedicated to managing a checkout procedure. This software interacts with a plurality of checkout peripherals deployed on the terminal 1, such as one or more item identification readers 12, a display device 13, payment devices, a receipt printer, a loudspeaker, semaphores and possibly one or more scales.

The central processing unit 11 is a microcomputer arranged inside a cabinet of the automatic checkout terminal 1, a remote server or, more generally, a motherboard provided with a processor, a memory and appropriate interfaces to allow it to operate and interact with various checkout peripherals.

The item identification reader 12 makes it possible, when an item 3 is presented in a predefined space 4, to identify said item if it is provided with suitable identification elements, such as a barcode (with one dimension or two dimensions, such as a matrix code or a quick-response code, better known as a QR code) or a radiofrequency identification chip. This item identification reader 12 may be for example an optical reader such as a barcode reader (commonly called scanners), or else a radiofrequency identification reader such as an RFID reader. The presentation space 4 corresponds to a spatial area or volume intended to receive an item 3 to be registered by the automatic checkout terminal 1. This space 4 is located in the field of action or within the range of the item identification reader 12.

The display device 13 is any user interface, interactive or otherwise, used by the automatic checkout terminal 1 to present information to the user throughout the checkout procedure. By way of non-exhaustive examples, this information may include an indication of the current step of the checkout procedure, information associated with an identifier read by the item identification reader 12 (such as a designation, a label, a name or description of the item 3 for ease of identification thereof on a receipt, a product reference, a serial number, a quantity, a weight, a price, a discount applied and/or an associated logo), an amount payable, payment options, instructions to follow, confirmations of operations, contextual messages (such as a greeting message, a goodbye message, an assistance message in the event of an error or requirement for assistance, or tooltips).

More generally, any information contributing to improving the ergonomics and accessibility of the automatic checkout terminal 1, by making user experience fluid and intuitive, may be displayed via the display device 13. This display device 13 is for example a touchscreen, a screen other than a touchscreen, or a customer display.

In particular, for the sake of transparency and trust, as soon as an item 3 is identified, it is registered among the items to be processed at a checkout and the user is informed of this by the display device displaying predefined information relating to this item 3. An item 3 may be identified by way of the item identification reader 12 or via manual inputting or selection of an identifier via an input peripheral of the automatic checkout terminal 1 (such as a keypad, a mouse or a touchscreen).

More generally, the display device 13 is configured to display information relating to an item 3 to be processed at a checkout. The user may thus follow the list of items to be processed at a checkout in real time. In some embodiments, registration of an identified item 3 is subject to a weight verification of this item 3 against an expected weight associated therewith. A weight of the item 3 may be determined when said item is retrieved from or placed in a tray of the automatic checkout terminal 1 incorporating an electronic scales.

The display device 13 receives, from the central processing unit 11, digital or analogue display signals containing information to be displayed. These signals represent graphical and/or textual data that are generally organized into images (or frames) corresponding to the full-screen display. The display signals represent, by way of non-exhaustive examples, a welcome screen and general instructions (for example logo and name of the point of sale, buttons to start a checkout procedure, buttons to select language), a real-time visualization of the content of the shopping basket (list of registered items 3 along with information relating thereto, subtotal and grand total to be paid, buttons to modify the shopping basket such as add/remove items 3), a summary of the content of the shopping basket and confirmation before payment, one or more payment method choices, a payment interface or payment instructions, a thank you and end-of-transaction message, or error and assistance messages.

For this purpose, the display device 13 is connected to the central processing unit 11 via a suitable port. The most commonly used ports include HDMI (High-Definition Multimedia Interface), DisplayPort or Mini DisplayPort, USB-C (or Thunderbolt 3/4), DVI (Digital Visual Interface), VGA (Video Graphics Array), SDI (Serial Digital Interface), along with proprietary ports, such as Lightning or Dock Connectors, specific to certain manufacturers. The choice of port depends on the capabilities of the central processing unit 11 (or its graphics card), the display device 13, technical constraints (such as resolution or refresh rate) and hardware compatibility. This connection ensures that the display signals are transmitted to the display device 13.

When a touchscreen is involved, the display device 13 interacts with the central processing unit 11 by transmitting information derived from user interactions. For example, when a user enters an identifier or selects an option on the touchscreen, the corresponding data are sent, in real time, to the central processing unit 11, which interprets them and adjusts the display signals in return.

As is also shown in FIG. 1, a monitoring system 2 intended to be deployed on the automatic checkout terminal 1 comprises at least one image sensor 21. This image sensor 21 is configured to acquire (or capture) at least one image of an item 3 to be processed at a checkout. The image sensor 21 is for example a 2D camera or a 3D camera (such as a time-of-flight camera, stereoscopic cameras, or structured-light cameras). Advantageously, a 3D camera provides an estimate of the shape and/or volume of the captured object, without employing multi-view processing.

The image sensor 21 makes it possible to acquire an image of an item 3 to be processed at a checkout, present in an area of interest. In one embodiment, this area of interest corresponds to the presentation space 4. In other words, when an item 3 is introduced into the presentation space 4, this item 3 is located at least partially in the area of interest of the field of view of the image sensor 21. For example, the optical axis of the image sensor 21 passes through the presentation space 4, which is located substantially at the centre of its field of view.

In another embodiment, the area of interest may be extended so as to cover a space surrounding the presentation space 4 (for example to the left, to the right and/or in front thereof, where an item 3 to be processed at a checkout may be present). In this case, the image sensor 21 makes it possible to acquire an image of an item 3 to be processed at a checkout, present in the vicinity of the presentation space 4 or in the immediate environment of the automatic checkout terminal 1. Indeed, an item 3 may be positioned close to the presentation space 4 or to the automatic checkout terminal, placed on the cabinet thereof, or else placed in a container such as a shopping basket or shopping trolley.

In one embodiment, the area of interest is defined based on the current step in the checkout procedure. For example, the area of interest comprises
the presentation space 4 during the step of registering the items 3, during which the user successively presents the items 3 to be processed at a checkout to the automatic checkout terminal 1;
a space located in the vicinity of the presentation space 4 or the automatic checkout terminal 1 at the end of the registration step, this transition being either explicitly indicated by the user or deduced automatically for example at the time when the payment step is triggered.

Of course, the monitoring system 2 may comprise a plurality of image sensors 21 each at least partially covering the area of interest. A plurality of image sensors 21 may be distributed so as to cover the area of interest as well as possible by offering a multi-angular view.

In one embodiment, the image sensor 21 is arranged above the presentation space 4, in a manner visible to the user, while avoiding covering the space facing the automatic checkout terminal 1 where the user is expected. For example, the image sensor 21 may be fixed to a mast overhanging the presentation space 4. This makes it possible to prevent capturing images of the user's face. The monitoring system 2 thus acts as a deterrent without jeopardizing the user's personal data. For strict data processing purposes, the acquired images are anonymized in one embodiment.

In one embodiment, the monitoring system 2 furthermore comprises a sound sensor, such as a microphone, configured to capture a predefined sound emitted by the automatic checkout terminal 1, in particular a sound (or an audible beep) indicating that the item identification reader 12 has read an identifier. In one embodiment, the sound sensor is a microphone or directional microphone array configured to pick up sound in a predefined direction, at one or more predefined frequencies and/or having a power greater than a predefined threshold value. This configuration makes it possible to detect a predefined sound emitted by the automatic checkout terminal 1 when an identifier is read by the item identification reader 12.

A processing module 22 of the monitoring system 2 is configured to determine, in at least one image (or in a plurality of successive images) acquired by the image sensor 21, a candidate item 3 corresponding to the item 3 to be processed at a checkout. For this purpose, the processing module 22 analyses the acquired images and carries out recognition of the item 3, by assigning a confidence score to the determination of the candidate item.

A determination, on the basis of at least one acquired image, of a candidate item corresponding to an item 3 present in a predefined area of interest may be obtained using any method known from the prior art, such as methods based on deep machine learning. Among these methods, mention may be made of convolutional neural networks (better known by the acronym CNN), region-based convolutional neural networks (R-CNN for short), fast region-based convolutional neural networks (Fast R-CNN for short) or faster region-based convolutional neural networks (Faster RCNN), or any other equivalent model.

In one embodiment, the processing module 22 is configured to determine at least one attribute relating to the item 3 present in an image acquired by the image sensor 21. An attribute designates any visual parameter, descriptor or specific feature of the item 3. Among these attributes, mention may be made of textual elements (a text present on the item 3, including distinctive keywords, typography or a specific font), graphic elements (a drawing, a symbol and/or a logo for example), colorimetric features (for example a dominance of certain colours or a histogram of colours), textural and structural properties (for example a surface texture or a visual pattern), dimensional and morphological parameters (for example a dimension, a proportion of dimensions, a contour or a general shape such as the shape of a bottle, a box, a packet, a pack, a sachet, a jar, a tray, a net, a blister pack, a roll, a can, a tube or a bar). These attributes may also include semantic elements used to associate certain visual features with a specific meaning, spatial relationships between pixels used for image structure analysis, or depth information to facilitate the assessment of the relief and volume of the item 3.

In one embodiment, attributes are determined by way of optical character recognition (OCR) carried out on characters visible on the item 3. A semantic analysis advantageously makes it possible to correct or supplement a missing datum in a textual attribute by using for example the N-gram model. The use of a plurality of attributes advantageously makes it possible to exploit incomplete data, such as a drawing or text determined only partially from the acquired images.

Preferably, a plurality of attributes of the item 3 are determined, so as to form an attribute vector. The one or more determined attributes is/are provided as input of a recognition method capable of estimating, with a coefficient, a score or a confidence index, a candidate item corresponding to the item 3. The higher the number of attributes, the higher the confidence score. The recognition method (CNN, R-CNN, Fast R-CNN, Faster R-CNN or equivalent models), in one embodiment, is based on machine learning trained with previously captured images of the item 3. Furthermore, in order to facilitate the detection of the item 3 in the area of interest, the image sensor 21 is preferably oriented so as to have a substantially static background.

Advantageously, the processing module 22, to determine a candidate item, uses at least one attribute from a list of attributes of the item 3 not comprising the identifier to be read by the item identification reader 12. In other words, to determine a candidate item corresponding to the item 3, the processing module 22 takes as a basis one or more attributes other than those used by the item identification reader 12.

In one embodiment, the processing module 22, to determine a candidate item corresponding to the item 3, uses one or more attributes other than a one-dimensional or two-dimensional barcode, in particular when the item identification reader 12 is an optical reader (a scanner). On the other hand, when the item identification reader 12 is an RFID reader, a barcode may be included among the attributes to be used to recognize the item 3. More generally, the processing module 22 and the item identification reader 12 refer to different attributes for identifying the item 3 to be processed at a checkout in order to improve the robustness of the monitoring system 2.

Moreover, the monitoring system 2 comprises a capture device 23 configured to retrieve, in real time, display signals intended for the display device 13 and convert these signals into content in the predefined format. The capture device 23 carries out an instantaneous capture of the display signals sent by the central processing unit 11 to the display device 13. The term “real time” or “instantaneous” is understood here to mean a capture of the display signals at the same time as they are sent to the display device 13, with a delay of almost zero. This results in faithful retrieval of the signals displayed by the display device 13.

More generally, the display signals retrieved by the capture device 23 represent the images visually displayed by the display device 13 or a copy of what is displayed by the display device 13.

The capture device 23 comprises for example a capture card or a display signal acquisition card, such as an HDMI capture card. In one embodiment, the capture device 23 is equipped with an input port intended to be connected to an output port of the central processing unit 11, from which a copy of the display signals sent to the display device 13 is able to be retrieved. For example, the input port is an HDMI input port (HDMI IN), a USB-C input port (USB-C IN), a DisplayPort input port, a DVI input port, a VGA input port, or an SDI input port.

In another embodiment, the capture device 23 comprises a splitter for duplicating the display signals intended for the display device. This splitter comprises at least two outputs and may be for example an HDMI splitter. The splitter intercepts and duplicates, without modification, the display signals simultaneously to the display device 13 and the capture device 23. In one embodiment, the splitter makes it possible, where applicable, to decode the display signals when they are encoded or protected.

In another embodiment, the capture device 23 is configured to intercept, process and retransmit the display signals to the display device 13. Specifically, the capture device 23 may be placed between the central processing unit 11 and the display device 13, enabling it to capture, in real time, the display signals before they reach the display device 13. Once intercepted, these signals may be processed in real time before being returned to the display device 13 without alteration and without any perceptible latency.

The capture device 23 converts (or transforms) the retrieved display signals into images (or frames), into video content or, more generally, into content in the predefined format allowing the processing module 22 to analyse it. This conversion makes it possible to obtain the images displayed by the display device 13.

The processing module 22 makes it possible to analyse the content of the display signals for various purposes, such as
improving user experience by observing the use of the checkout software in order to optimize its ergonomics (analysis of the total time, the time spent on each step of the checkout procedure, interactions and scenarios, as well as following the checkout procedure);
carrying out training by recording checkout sessions in order to create tutorials and make the checkout software easier to handle; and/or
real-time monitoring of the checkout procedure.

Computer-vision and artificial-intelligence tools may be used to automatically analyse and interpret the content of the display signals, such as optical character recognition (OCR) or shape or object recognition software known from the prior art.

A step of preliminary deep machine learning of the various steps and pages of the checkout software, along with a database incorporating information concerning the items 3 offered for sale, advantageously makes it possible to extract and recognize the content of the images conveyed by the display signals.

To monitor the checkout procedure, the processing module 22, in one embodiment, is configured to verify the presence or absence, in the content of the display signals, of information relating to the candidate item determined from at least one image acquired by the image sensor 21. This search aims to ensure a match between the candidate item and the item 3 to be processed at a checkout or, where applicable, to ensure the presence of the candidate item among the registered items. This search is preferably carried out in real time, in other words the time that the display device 13 displays the item 3 that has just been registered or, more generally, during the checkout procedure (in particular before termination thereof). Information relating to the candidate item may include, on its own or in combination, a designation, a label, a brand, a description, a product reference, a serial number, a weight, a volume, a price, a logo, a graphic object, a code or, more generally, any information used to identify this item on a receipt or invoice.

An absence of information relating to the candidate item in the content of the display signals may be considered by the monitoring system 2 to be a lack of a match between the identifier read by the item identification reader 12 and the registered item 3, in particular due to
a suspicious modification of the identifier of the item 3, such as a change of the barcode or RFID chip of the item 3, or reading the identifier of an element in a pack rather than reading the identifier of the pack (in particular reading the incorrect barcode);
incorrect manual registration of the item 3, such as incorrect selection or entry of an identifier of the item 3 by the customer or cashier (for example in the case of an item without an identifier, such as a fresh food product);
a labelling error, whether intentional or unintentional, for example in the case of a bulk product (such as fruit and vegetables, or a self-service product with personalized packaging or fresh bulk products) weighed and labelled by the customer.

An absence of information relating to the candidate item in the content of the display signals may also be considered by the monitoring system 2 to be an absence of presentation (non-scanning) of the item 3 to the automatic checkout terminal 1, in particular due to
intentionally or unintentionally forgetting to register this item 3 and moving to the payment step (for example an item 3 left in or under the shopping trolley or in the vicinity of the automatic checkout terminal 1 or on the cabinet thereof); or
suspicious presentation of the item 3 by adopting a gripping posture on the item 3 that prevents its identifier from being read by the item identification reader 12 (for example, masking the barcode with the user's hand 5 or orienting the item 3 so as to hide its identifier from the item identification reader 12).

When the item 3 is located in an area of interest covering the environment of the automatic checkout terminal 1, the processing module 22 advantageously makes it possible to detect the absence of presentation (or non-scanning) of this item 3 to the automatic checkout terminal 1 when no information concerning same appears in the content of the display signals transmitted to the display device 13. However, an item 3 present in the environment of the automatic checkout terminal 1 (for example in a shopping trolley or shopping basket) may be considered to be presented and correctly taken into account if the content of the display signals is verified as containing (in the corresponding quantity) information relating to the candidate item associated therewith. This is in particular the case for example for an item 3 given a detachable label, allowing it to be registered without manipulating the item 3 directly (for example a pack of water or, more generally, a bulky or cumbersome item).

In one embodiment, suspicious presentation of an item 3 to the item identification reader 12 may be detected by the absence, at the time of this presentation, of the capture of a predefined sound by the sound sensor. In other words, determination of a candidate item corresponding to an item introduced into the presentation space 4 without capture of a sound confirming that an identifier has been read by the item identification reader 12 is interpreted by the processing module 22 as suspicious presentation of the item 3. Capturing the predefined sound thus makes it possible to confirm that an item 3 has been correctly presented. A match between the read identifier and the presented item 3 may be confirmed by verifying the presence, in the content of the display signals, of information relating to the candidate item corresponding to this item 3.

When a document bearing an identifier, whether physical or dematerialized, such as a loyalty card, a gift card, a discount coupon, a voucher or a detachable label, is presented to the item identification reader 12, a generic candidate item may be associated therewith. Analysing the content of the display signals makes it possible to specify the generic candidate item.

Moreover, real-time analysis of the content of the display signals advantageously makes it possible to detect an incomplete checkout procedure, in particular in cases where a customer leaves the automatic checkout terminal 1 without having finalized their payment. This detection makes it possible to identify situations in which one or more items 3 have been registered but not paid for, either unintentionally (forgetting, technical problem) or intentionally (attempted fraud).

The presence, in the content of the display signals, of information relating to the candidate item makes it possible to validate the correctness of the identifier detected by the item identification reader 12. This also guarantees that each candidate item, determined from the acquired images, is indeed present in the list of items to be processed at a checkout. Advantageously, this results in increased monitoring of the checkout procedure, making it possible to prevent theft and attempted fraud.

In one embodiment, the processing module 22 is configured to extract a text from the content of the display signals. For this purpose, the processing module 22, in one embodiment, comprises optical character recognition (OCR) software for detecting and extracting a text in an image or a text in a video conveyed by the display signals. The extracted text comprises, during the successive registration of the items 3 to be processed at a checkout, in particular information associated with the identifiers read by the item identification reader 12. The presence or absence of information relating to the candidate item is verified in the extracted text. Artificial intelligence models, regular expressions and/or fuzzy logic algorithms may be used to carry out such verification. Advantageously, this verification makes it possible to reduce the latency of the monitoring system 2 (reduce the time lag between the result of the verification and the displaying of the text extracted by the display device 13).

In another embodiment, the processing module 22 is configured to verify the presence or absence of information relating to the candidate item in a portion of the content of the display signals. In one embodiment, this portion is the new portion of the content, that is to say recent changes or additions (in other words the elements that have changed between two successive images). This new portion may be obtained using various methods such as image subtraction, modelling of static elements (such as buttons, titles, icons or navigation bars of the graphical user interface of the checkout software), the use of neural networks to detect new objects in the content, extraction of regions of interest in the graphical user interface of the checkout software, key image selection at regular intervals or based on the current step of the checkout procedure, or even a combination of these techniques.

Advantageously, verifying the presence or absence of information relating to the candidate item in a specific portion of the content of the display signals (rather than in the entire content) makes it possible to maximize the efficiency of the processing module 22 while reducing latency for smooth and accurate real-time analysis (without any delay perceptible to the user).

The processing module 22 is configured to generate an alert or, more generally, a message and/or to activate an additional check, in the event of absence of information relating to the candidate item in the content of the display signals. A message may be addressed to the user of the automatic checkout terminal 1 or to a member of checkout staff. In one embodiment, the message generated by the processing module 22 is displayed on a screen 24 and/or signalled via a semaphore or a loudspeaker to assist the user, invite them to rescan the item 3 in question, or ask them to confirm that all items to be processed at a checkout have been registered.

In one embodiment, the processing module 22 comprises an error report generation and trend analysis functionality. These reports make it possible to identify recurring problems and propose improvements to reduce inventory shrinkage and unintentional checkout errors. The processing module 22 may be designed to be interactive, enabling checkout staff to provide feedback regarding the messages generated. This feedback could be used to refine the messages and improve the overall user experience.

When a screen 24 is used to display the messages from the processing module 22, this screen 24 may also be used to display promotional messages related to any one of the candidate items determined by this processing module 22.

In another embodiment, the processing module 22 is configured to determine, from the images acquired by the image sensor 21 and the content of the display signals, a sequence of events occurring during the checkout procedure. This sequence constitutes a kind of narrative, or story, detailing the entire checkout process chronologically, whether in the form of images, text or a combination of both. A checkout event denotes any action able to be detected from the acquired images (for example, “presenting an item for registration”, “determining a candidate item” or “failure to determine a candidate item”), in particular when determining a candidate item, or involving a modification in the content of the display signals (for example, “initiating a checkout procedure”, “reading an identifier”, “removing an item”, “validating a shopping basket”, “selecting a payment method”, “validating a payment”, “payment declined”, “goodbye message”). In one embodiment, these events are selected from a predefined list of events. The processing module 22 is configured to generate an alert or, more generally, a message when the sequence of events deviates from a predefined sequence of events. The processing module 22 follows the sequence of events that have occurred and generates an alert message (audible and/or visual) as soon as a deviation from a predefined scenario is detected (such as an incomplete checkout procedure, a repeated failure to recognize an item 3, a successive failure to read the identifier of an item 3, or the repeated addition and removal of a given item 3).

The monitoring system 2 thus advantageously makes it possible to monitor the checkout procedure in real time, to detect any anomaly and to ensure that its progress follows one of the predefined scenarios, without any omissions or errors with the registration of the items 3. The processing module 22 may also generate detailed reports regarding the detected anomalies, providing valuable analyses to optimize the checkout procedure.

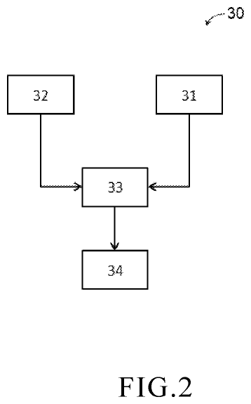

FIG. 2 displays steps of a method 30 for monitoring a checkout procedure (or session) on the automatic checkout terminal 1.

As described above, this method 30 comprises a step of retrieving 31, in real time and by way of the capture device 23, display signals intended for the display device 13 and converting these signals into content in the predefined format (for example video content, images or frames).

In one embodiment, these signals are retrieved with the aid of an acquisition card provided with an input port compatible with a second output port for display signals, available on the central processing unit 11. As an alternative, the capture device 23 comprises a capture card (for example an HDMI card) provided with a splitter for duplicating the display signals sent by the central processing unit 11 to the display device 13.

The monitoring method 30 furthermore comprises a step 32 of acquiring, by way of the image sensor 21, an image of an item 3 to be processed at a checkout and of determining, at least from this image, a candidate item corresponding to the item 3 to be processed at a checkout. In one embodiment, the acquisition of images by the image sensor 21 is triggered by the detection of initiation of the checkout procedure by analysing the content of the display signals. The image acquisition may be suspended or stopped when a checkout procedure is terminated.

Determining a candidate item 3 corresponding to the item 3, at least from an image acquired by the image sensor 21 covering an area of interest (in particular the presentation space 4 or at least partially the environment of the automatic checkout terminal 1), makes it possible to recognize said item with a confidence index. This recognition is based on visual attributes (or markers) other than the one used by the item identification reader 12 when this is an optical reader (a barcode scanner). The environment of the automatic checkout terminal 1 may include the presentation space 4 for the items 3, the cabinet or structure of the terminal 1, the deposition area for items 3 that have already been registered or are to be registered, the weighing space (if present), the immediate space around the terminal 1 able to receive items 3 to be processed at a checkout or a shopping trolley or shopping basket containing items 3 to be processed at a checkout. More generally, the environment of the automatic checkout terminal 1 may include areas where the customer interacts with the terminal 1 and their items 3 to be processed at a checkout.

By using the determined candidate item 3, on the one hand, and the content of the display signals, on the other hand, the monitoring method 30 comprises a step 33 of verifying the presence or absence of information relating to the candidate item in this content. Advantageously, this verification step 33 makes it possible to ensure that the candidate item 3 and the identifier read by the item identification reader 12 indeed correspond to the same item 3. In other words, this verification step 33 makes it possible to ensure a match between the information determined from the acquired images and that determined by the item identification reader 12. This verification also makes it possible to determine whether or not an item 3 to be processed at a checkout, present in the environment of the automatic checkout terminal 1, has been registered (whether it is presented without having been registered, or even not presented at all).

In one embodiment, the monitoring method 30 comprises a step of extracting a text from the content of the display signals, the presence or absence of said information being verified in the extracted text.

Moreover, the monitoring method 30 may also comprise a step of determining, from at least one image acquired by the image sensor 21 and the content of the display signals, a sequence of events occurring during a checkout procedure and a step of generating a message when the sequence of events deviates from a predefined sequence of events.

Joint and correlated observation of the environment of the automatic checkout terminal 1 by way of the image sensor 21 (possibly in combination with a sound sensor) and of the content of the display signals by way of the capture device 23 advantageously makes it possible to detect an unregistered item 3 (presented without having been registered, or not presented at all); an error in the registration of an item 3, as well as the lack of completion of a checkout procedure.

Advantageously, the embodiments presented above are particularly suitable for combating theft, reducing inventory shrinkage and correcting unintentional errors in automatic checkout terminals. They ensure discreet and effective protection without disrupting user experience or impacting existing checkout software. They may be deployed in addition to existing infrastructures, thus offering points of sale a flexible and scalable solution to optimize security and reliability of transactions. As an alternative, the monitoring system 2 may be an integral part of the checkout terminal 1.

It should be noted that it is not necessary for the checkout terminal 1, in the various embodiments presented above, to be automatic in the strict sense of the term (that is to say operating as a self-service checkout or self-checkout). Indeed, this terminal 1 may, more generally, be any type of checkout system, including a traditional standard checkout terminal. In this case, the user of the checkout terminal 1 is not necessarily the customer, but may be a member of staff of the point of sale.

1. A monitoring system (2) intended to be deployed on a checkout terminal (1) incorporating a display device (13) configured to display information relating to an item (3) to be processed at a checkout, this system (2) comprising
an image sensor (21) configured to acquire an image of said item (3);
a processing module (22) configured to determine, in said image, a candidate item corresponding to said item (3) to be processed at a checkout;
this system (2) being characterized in that it furthermore comprises
a capture device (23) configured to retrieve, in real time, display signals intended for the display device (13) and convert these signals into content in the predefined format;
the processing module (22) being furthermore configured to verify the presence or absence of information relating to the candidate item in said content.

2. The monitoring system (2) according to claim 1, characterized in that the capture device (23) comprises a splitter for duplicating the display signals intended for the display device (13).

3. The monitoring system (2) according to claim 1, characterized in that the processing module (22) is configured to verify the presence or absence of information relating to the candidate item in a portion of said content.

4. The monitoring system (2) according to claim 1, characterized in that the processing module (22) is furthermore configured to extract a text from said content, the presence or absence of said information being verified in the extracted text.

5. The monitoring system (2) according to claim 1, characterized in that the processing module (22) uses one or more attributes of the item (3) other than a barcode to determine the candidate item.

6. The monitoring system (2) according to claim 1, characterized in that it furthermore comprises a sound sensor configured to capture a predefined sound emitted by the checkout terminal.

7. The monitoring system (2) according to claim 1, characterized in that the processing module (22) is furthermore configured to determine, from said image and said content, a sequence of events occurring during a checkout procedure and to generate a message when said sequence of events deviates from a predefined sequence of events.

8. A method (30) for monitoring a checkout procedure on a checkout terminal (1) incorporating a display device (13) configured to display information relating to an item (3) to be processed at a checkout, this method comprising the following steps
acquiring (32) an image of said item (3) by way of an image sensor (21);
determining, at least from the acquired image, a candidate item corresponding to said item to be processed at a checkout;
this method being characterized in that it furthermore comprises
a step of retrieving (31), in real time and by way of a capture device, display signals intended for the display device (13) and converting these signals into content in the predefined format;
a step of verifying (33) the presence or absence of information relating to the candidate item in said content.

9. The method (30) according to claim 8, characterized in that it furthermore comprises a step of extracting a text from the content of the display signals, the presence or absence of said information being verified in the extracted text.

10. The method (30) according to claim 8, characterized in that it furthermore comprises a step of determining, from said image and said content, a sequence of events occurring during a checkout procedure and a step of generating a message when the sequence of events deviates from a predefined sequence of events.
